(19) United States
(12) Patent Application Publication
(10) Pub. No.: US 2020/0236696 A1
(43) Pub. Date: Jul. 23, 2020

(54) USER APPARATUS AND BASE STATION APPARATUS

(71) Applicant: NTT DOCOMO, INC., Tokyo (JP)

(72) Inventors: Hideaki Takahashi, Chiyoda-ku, Tokyo (JP); Yousuke Sano, Chiyoda-ku, Tokyo (JP); Hiromasa Umeda, Chiyoda-ku, Tokyo (JP)

(73) Assignee: NTT DOCOMO, INC., Tokyo (JP)

(21) Appl. No.: 16/652,314

(22) PCT Filed: Sep. 25, 2018
(86) PCT No.: PCT/JP2018/035511

§ 371 Date: Mar. 30, 2020

(30) Foreign Application Priority Data
Oct. 6, 2017 (JP) 2017-195877

(51) Int. Cl. H04W 72/12; H04W 74/04; H04W 74/00; H04W 8/24; H04W 16/32

(52) U.S. Cl. CPC H04W 72/1268; H04W 74/04; H04W 16/32; H04W 8/24; H04W 74/004

(57) ABSTRACT

A user apparatus communicates with a base station. The user apparatus includes a generation unit configured to generate terminal capability information including information indicating an uplink band combination and information indicating whether capable of simultaneous transmission in the uplink band combination, a transmission unit configured to transmit the generated terminal capability information to the base station apparatus, and a reception unit configured to receive an uplink scheduling assignment from the base station apparatus. The simultaneous transmission is performed in the uplink band combination based on the uplink scheduling assignment.

### BACKGROUND OF THE INVENTION

### 1. Field of the Invention

The present invention relates to a user apparatus and a base station apparatus in a wireless communication system.

### 2. Description of the Related Art

Currently, in 3GPP (Third Generation Partnership Project), specifications have been developed for a new wireless communication system that is called “NR (New Radio Access Technology) system” as a successor of “LTE (Long Term Evolution) system” and “LTE-Advanced system” (e.g., non-patent document 1).

In the NR system, introduction of a technology called “LTE-NR Dual Connectivity” or “Multi-RAT (Multi Radio Access Technology) Dual Connectivity” has been discussed, in which, similar to the Dual Connectivity in the LTE system, data sets are divided between a base station of an LTE system (eNB) and a base station of an NR system (gNB) and the divided data sets are simultaneously transmitted to or received by the base stations (e.g., non-patent document 2).

### CITATION LIST

### Non-Patent Document

### [Non-Patent Document 1] 3GPP TR38.804 V14.0.0 (2017-03)

### [Non-Patent Document 2] 3GPP TS37.340 V1.0.2 (2017-09)

### SUMMARY OF THE INVENTION

### Technical Problem

In the LTE-NR Dual Connectivity, an inter-modulation distortion (IMD) and higher harmonic waves may be generated in two or more uplink transmissions. In this case, the generated IMD and higher harmonic waves may fall in a downlink reception band of LTE component carriers or NR component carriers at a user apparatus (User Equipment: UE), and may generate interference (in-device interference) in the user apparatus. In particular, an NR system tends to be influenced (affected) by the IMD because the NR system uses a wide bandwidth such as a 28 GHz band.

The above-described matter is not limited to the Dual Connectivity between the LTE system and the NR system. There is a possibility that the IMD and higher harmonic waves, generated by two or more uplink transmissions, may fall in (may be, may impact, or may hit) a reception band and may generate in-device interference.

In view of the above-described problem, an object of the present invention is to provide a communication technology in which influence of the in-device interference is reduced in the dual connectivity performed in a wireless communication system using a plurality of RATs.

### Solution to Problem

According to an embodiment of the present invention, a user apparatus that communicates with a base station apparatus is provided. The user apparatus includes a generation unit configured to generate terminal capability information including information indicating an uplink band combination and information indicating whether capable of simultaneous transmission in the uplink band combination, a transmission unit configured to transmit the generated terminal capability information to the base station apparatus, and a reception unit configured to receive an uplink scheduling assignment from the base station apparatus. The simultaneous transmission is performed in the uplink band combination based on the uplink scheduling assignment.

### Advantageous Effects of Invention

According to an embodiment of the present invention, it is possible to perform communications in which influence of the in-device interference is reduced in the dual connectivity performed in a wireless communication system using a plurality of RATs.

### BRIEF DESCRIPTION OF THE DRAWINGS

FIG. 1 is a drawing illustrating an inter-modulation distortion (IMD) in the LTE-NR dual connectivity.

FIG. 2 is a drawing illustrating an example in which an IMD is generated in the band combination of the LTE-NR dual connectivity.

FIG. 3 is a configuration example of a wireless communication system according to an embodiment of the present invention.

FIG. 4 is a sequence diagram in which a user apparatus 200 according to an embodiment of the present invention transmits capability information to a base station apparatus 100.

FIG. 5 is a drawing illustrating an example of a band combination in the LTE-NR dual connectivity according to an embodiment of the present invention.

FIG. 6 is a drawing illustrating an example of specified MSD for the band combination according to an embodiment of the present invention.

FIG. 7 is a drawing illustrating an example of a capability indication related to MSD according to an embodiment of the present invention.

FIG. 8 is a drawing illustrating an example of a functional structure of a base station apparatus 100 according to an embodiment of the present invention.

FIG. 9 is a drawing illustrating an example of a functional structure of a user apparatus 200 according to an embodiment of the present invention.

FIG. 10 is drawing illustrating an example of a functional structure of a user apparatus 100 and a base station apparatus 200 according to an embodiment of the present invention.

### DETAILED DESCRIPTION OF THE PREFERRED EMBODIMENTS

In the following, referring to the drawings, one or more embodiments of the present invention will be described.

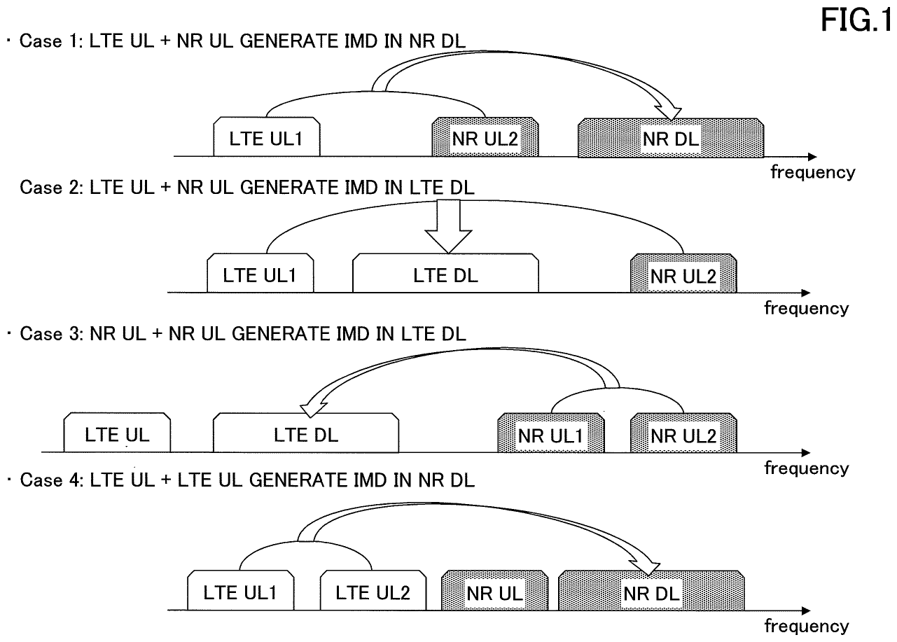

FIG. 1 is a drawing illustrating an inter-modulation distortion (IMD) in the LTE-NR dual connectivity.

In one or more embodiments below, a base station apparatus 100 and a user apparatus 200 are provided, which support dual connectivity between a plurality of wireless communication systems using different RATs, that is, multi-RAT dual connectivity. Further, in one or more embodiments, in-device interference, which is generated by the inter-modulation distortion (IMD), higher harmonic waves, or the like, in the dual connectivity between the LTE system and the NR system (LTE-NR dual connectivity), will be described. In the LTE-NR dual connectivity, there are four typical cases in which the in-device interference is generated as illustrated in FIG. 1.

Regarding case 1, in the uplink dual connectivity (LTE UL1+NR UL2) using an uplink carrier of the LTE system (LTE UL1) and an uplink carrier of the NR system (NR UL2), inter-modulation distortion, which is caused by a combination of LTE UL1 and NR UL2, and/or higher harmonic waves, which are caused by transmission of LTE UL1 or NR UL2, fall in a downlink carrier of the NR system (NR DL), and generate in-device interference in NR DL.

Regarding case 2, in the uplink dual connectivity (LTE UL1+NR UL2) using an uplink carrier of the LTE system (LTE UL1) and an uplink carrier of the NR system (NR UL2), inter-modulation distortion, which is caused by a combination of LTE UL1 and NR UL2, and/or higher harmonic waves, which are caused by transmission of LTE UL1 or NR UL2, fall in a downlink carrier of the LTE system (LTE DL), and generate in-device interference in LTE DL.

Regarding case 3, in the uplink dual connectivity (NR UL1+NR UL2) using two uplink carriers of the NR system (NR UL1, NR UL2), inter-modulation distortion, which is caused by a combination of NR UL1 and NR UL2, and/or higher harmonic waves, which are caused by transmission of NR UL1 or NR UL2, fall in a downlink carrier of the LTE system (LTE DL), and generate in-device interference in LTE DL.

Regarding case 4, in the uplink dual connectivity (LTE UL1+LTE UL2) using two uplink carriers of the LTE system (LTE UL1, LTE UL2), inter-modulation distortion, which is caused by a combination of LTE UL1 and LTE UL2, and/or higher harmonic waves, which are caused by transmission of LTE UL1 or LTE UL2, fall in a downlink carrier of the NR system (NR DL), and generate in-device interference in NR DL.

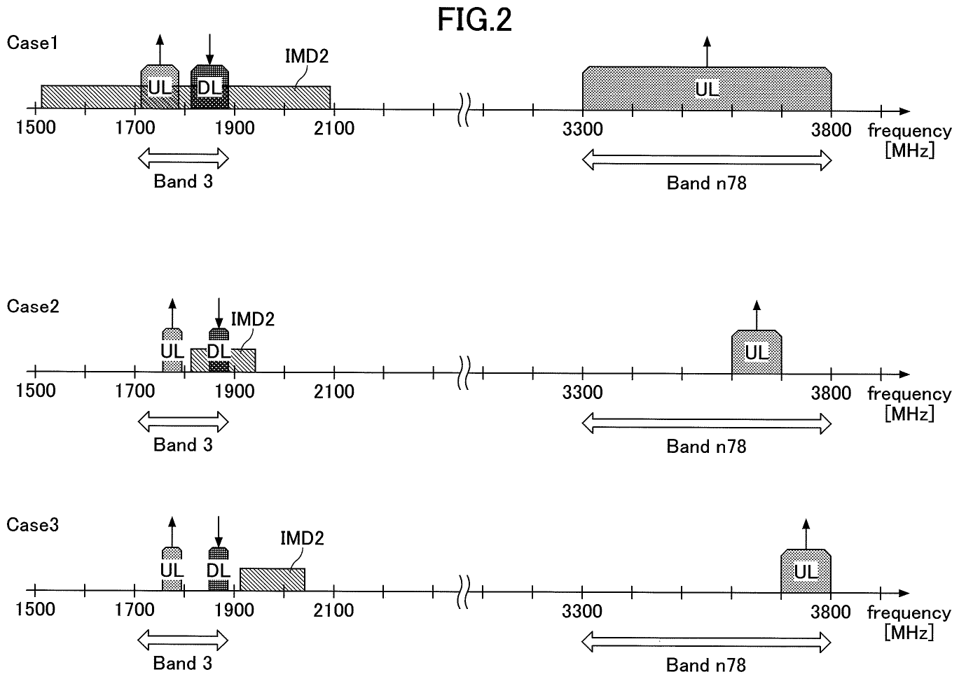

FIG. 2 is a drawing illustrating an example in which IMD is generated in the band combination of the LTE-NR dual connectivity.

A band combination of the LTE-NR dual connectivity in Case 1 illustrated in FIG. 2 is an example including LTE Band 3, UL (Uplink) 1710 MHz-1785 MHz, DL (Downlink) 1805 MHz-1880 MHz, and NR Band n78, UL 3300 MHz-3800 MHz. Regarding Case 1, in the case where LTE UL and NR UL are simultaneously transmitted, secondary inter-modulation distortion (i.e., IMD2) is generated in 1515 MHz-2095 MHz. As illustrated in Case 1, the IMD2 interferes with LTE DL.

Case 2 and Case 3 illustrated in FIG. 2 are examples in which IMD is generated in the case where channel band widths in the band are further specified. The channel band width combination in the band combination of LTE-NR dual connectivity in Case 2 is an example in which the channel band width in LTE Band 3 is 20 MHz (UL: 1765 MHz-1785 MHz, DL: 1860 MHz-1880 MHz), and the channel band width in NR Band n78 is 100 MHz (UL: 3600 MHz-3700 MHz). Regarding Case 2, in the case where LTE UL and NR UL are simultaneously transmitted, an IMD2 is generated in 1815 MHz-1935 MHz. As illustrated in Case 2, the IMD2 interferes with LTE DL.

The channel band width combination in the band combination of LTE-NR dual connectivity in Case 3 is an example in which the channel band width in LTE Band 3 is 20 MHz (UL: 1765 MHz-1785 MHz, DL: 1860 MHz-1880 MHz), and the channel band width in NR Band n78 is 100 MHz (UL: 3700 MHz-3800 MHz). Regarding Case 3, in the case where LTE UL and NR UL are simultaneously transmitted, an IMD2 is generated in 1915 MHz-2035 MHz. As illustrated in Case 3, the IMD2 does not interfere with LTE DL.

### Embodiment

In the following, one or more embodiments will be described.

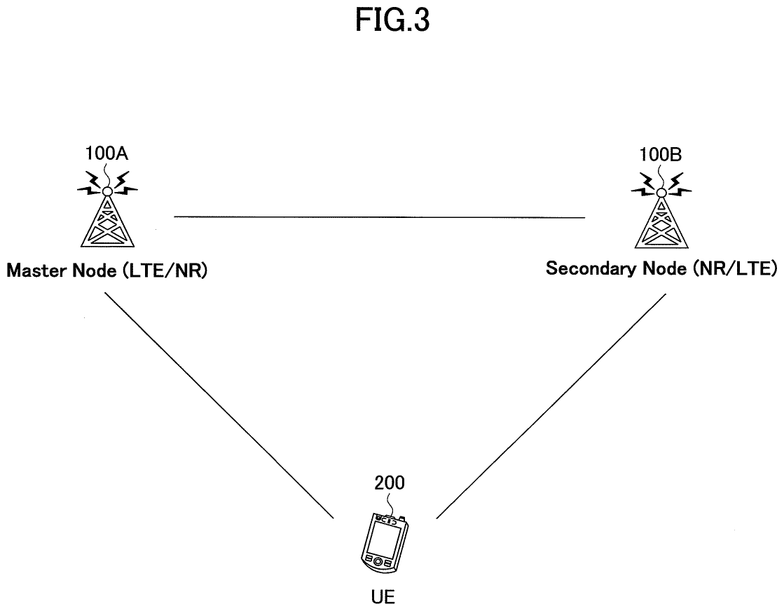

FIG. 3 is a configuration example of a wireless communication system according to an embodiment of the present invention. FIG. 3 is a schematic diagram illustrating a wireless communication system according to an embodiment of the present invention.

As illustrated in FIG. 3, a user apparatus 200 communicates with (is connected to) a base station apparatus 100A and a base station apparatus 100B provided by the LTE system and the NR system, respectively (hereinafter, referred to as “base station apparatus 100” in the case of not distinguishing between the base station apparatus 100A and the base station apparatus 100B). Further, the user apparatus 200 supports LTE-NR dual connectivity in which the base station apparatus 100A is a master base station and the base station apparatus 100B is a secondary base station. In other words, it is possible for the user apparatus 200 to perform simultaneous transmission to or simultaneous reception from the master base station apparatus 100A and the secondary base station apparatus 100B by simultaneously using a plurality of component carriers provided by the master base station apparatus 100A and the secondary base station apparatus 100B. It should be noted that, although a single base station is included in each of the LTE system and the NR system in an embodiment illustrated in the figure, in general, many base stations are arranged in order to cover the service areas of the LTE system and the NR system.

It should be noted that, although the LTE-NR dual connectivity will be described in the following embodiments, it should be easily understood by a person skilled in the art that a user apparatus according to an embodiment of the present invention is not limited to the above, and may be applied to dual connectivity between a plurality of wireless communication systems using different RATS, that is, the multi-RAT dual connectivity.

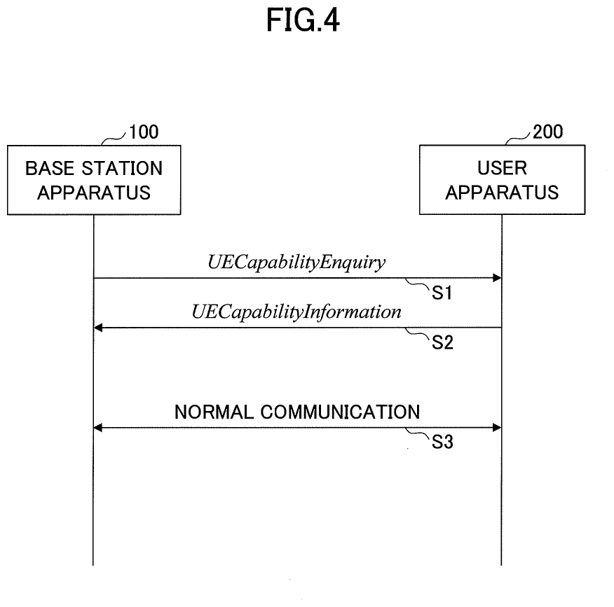

FIG. 4 is a sequence diagram in which a user apparatus 200 according to an embodiment of the present invention transmits terminal capability information to a base station apparatus 100. In FIG. 4, the base station apparatus 100 transmits a terminal capability transmission request to the user apparatus 200, and the user apparatus 200 transmits terminal capability information to the base station apparatus 100 in response to the terminal capability transmission request.

In step S1, the base station apparatus 100 transmits, as a terminal capability transmission request, an RRC (Radio Resource Control) message “UECapabilityEnquiry” to the user apparatus 200. “UECapabilityEnquiry” is used by a network in order to obtain information related to radio access capability of the user apparatus 200. It is possible for the base station apparatus 100 to specify the type of radio access capability included in the information transmitted by the user apparatus 200 by using “UECapabilityEnquiry”. For example, the base station apparatus 100 may request for transmission of radio access capability related to the band combination supported by the user apparatus 200. The radio access capability related to the band combination may include information indicating whether capable of simultaneous UL transmission in each of the band combinations.

Next, in step S2, the user apparatus 200 transmits, as the terminal capability information, an RRC message “UECapabilityInformation” to the base station apparatus 100. “UECapabilityInformation” is used for transmitting information related to radio access capability of the user apparatus 200 to the network. The user apparatus 200 transmits information related to radio access capability supported by the user apparatus 200 to the base station apparatus 100 based on the “UECapabilityEnquiry” received from the base station apparatus 100 in step S1.

In step S3, the base station apparatus 100 performs normal communications adapted to the terminal capability according to the “UECapabilityInformation” received from the user apparatus 200 in step S2. For example, in the case where information indicating the supported band combinations and information indicating capability or non-capability of the simultaneous UL transmissions are included in the “UECapabilityInformation” received from the user apparatus 200 in step S2, the base station apparatus 100 performs the scheduling within a range of the supported band combinations. In the case of being capable of simultaneous UL transmissions, the base station apparatus 100 may perform the scheduling that causes the user apparatus 200 to perform the simultaneous UL transmissions.

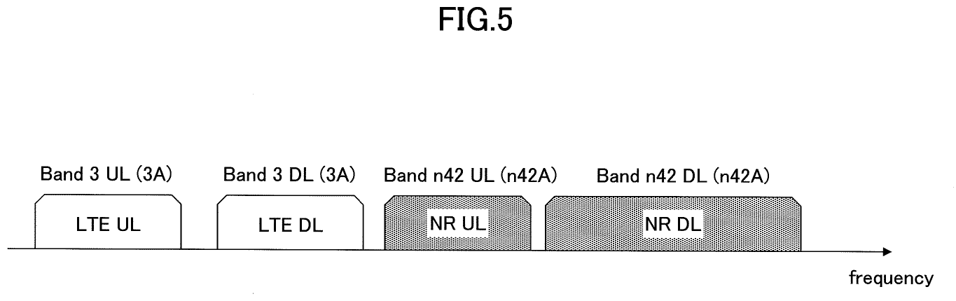

FIG. 5 is a drawing illustrating an example of a band combination in the LTE-NR dual connectivity according to an embodiment of the present invention. Referring to FIG. 5, an example of a band combination in the LTE-NR dual connectivity will be described, and transmission, from the user apparatus 200 to the base station apparatus 100, of terminal capability information related to the band combination and the simultaneous UL transmissions will be described.

The UL band combination in the LTE-NR dual connectivity will be defined as follows. For example, as illustrated in FIG. 5, a UL band combination “UL 3A+n42A” defines that a CC (Carrier Component) with a bandwidth of 20 MHz is supported in Band 3 that is an LTE 1.7 GHz band and a CC with a bandwidth of 20 MHz is supported in Band n42 that is an NR 3.5 GHz band. “a CC with 20 MHz width” is indicated by “A” included in “3A” or in “n42A”, which corresponds to “CA BW class A” (Carrier aggregation bandwidth class A). It should be noted that “CA BW class A” may indicate “a CC with a bandwidth equal to or less than 20 MHz”. It should be noted that a DL band combination “DL 3A+n42A” may be similarly defined as the “UL 3A+n42A”.

Here, in the case where a UL band combination for the LTE-NR dual connectivity is transmitted from a user apparatus 200 to a base station apparatus 100 as terminal capability (i.e., UE capability), the base station apparatus 100 may determine that the user apparatus 200 is capable of performing UL simultaneous transmission in the UL band combination. The user apparatus 200 may set the UL band combination for the LTE-NR dual connectivity in the UE capability and transmit the set result to the base station apparatus 100 when the user apparatus 200 is capable of performing UL simultaneous transmission in the UL band combination. For example, in the case where “UL 3A+n42A”, as illustrated in FIG. 5, is transmitted from the user apparatus 200 to the base station apparatus 100, it may be indicated that the user apparatus 200 is capable of simultaneously transmitting “LTE UL 3A” and “NR UL n42A” without explicitly transmitting information indicating the capability of simultaneous transmission.

Further, in the case where a bit (one bit indicator) corresponding to terminal capability “single Tx UE” is transmitted as the UE capability in addition to the UL band combination for the LTE-NR dual connectivity, the base station apparatus 100 may determine that the user apparatus 200 is capable of performing UL transmission using a single CC in one of the bands included in the UL band combination. In other words, the user apparatus 200 may set the UL band combination for the LTE-NR dual connectivity and a bit indicating correspondence to “single Tx UE” in the UE capability and transmit the set result to the base station apparatus 100 when the user apparatus 200 is capable of performing UL transmission using a single CC in one of the bands included in the UL band combination. For example, in the case where “UL 3A+n42A” and a bit indicating correspondence to “single Tx UE” are transmitted from the user apparatus 200 and the base station apparatus 100, the user apparatus 200 is capable of performing UL transmission using a CC of one of “LTE UL 3A” and “NR UL n42A”, that is, capable of performing UL transmission in “LTE UL 3A” or “UL n42A”.

Further, in the case where a bit (one bit indicator) indicating the terminal capability of “not being capable of performing simultaneous transmission in the UL band combination” is transmitted as the UE capability in addition to the UL band combination for the LTE-NR dual connectivity, the base station apparatus 100 may determine that the user apparatus 200 is not capable of performing simultaneous UL transmission in the UL band combination. In other words, the user apparatus 200 may set, in the UE capability, the UL band combination for the LTE-NR dual connectivity and a bit indicating that the user apparatus 200 is not capable of simultaneous UL transmission in the UL band combination and transmit the set result to the base station apparatus 100 when the user apparatus 200 is not capable of performing simultaneous UL transmission in the UL band combination. For example, in the case where “UL 3A+n42A”, illustrated in FIG. 5, and a bit indicating that the user apparatus 200 is not capable of simultaneous UL transmission in the UL band combination are transmitted from the user apparatus 200 to the base station apparatus 100, the user apparatus 200 is not capable of performing the simultaneous UL transmission in “LTE UL 3A” and “NR UL n42A”. It should be noted, however, that the user apparatus 200 is capable of performing UL transmission in each of “LTE UL 3A” and “NR UL n42A”, not in the case of simultaneous transmission, but in the case of time division transmission.

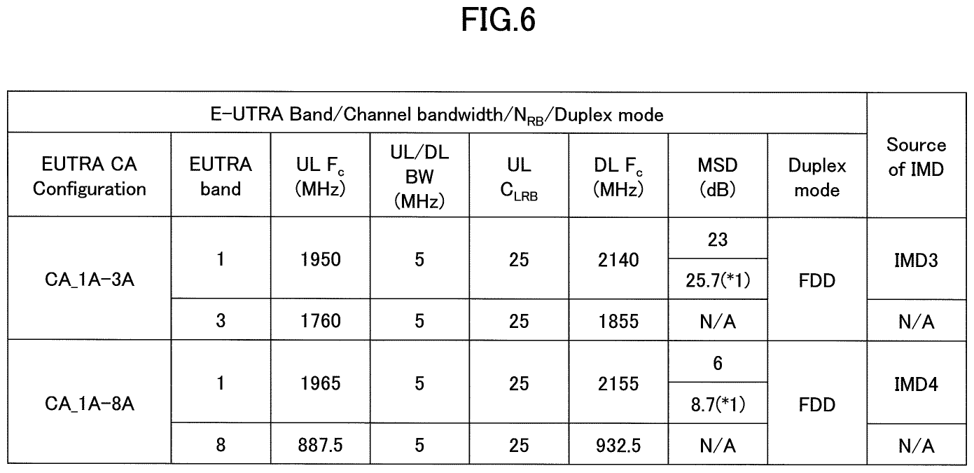

FIG. 6 is a drawing illustrating an example of specified MSD for band combinations according to an embodiment of the present invention. An example is illustrated in FIG. 6 in which MSD (Maximum Sensitivity Degradation) is specified in LTE CA band combinations. The MSD is a value indicating the maximum reception sensitivity degradation in the interfered band in the case where the simultaneous transmission is performed in a given band combination.

In the case where the “EUTRA band” is “1” in the CA band combination “CA_1A-3A”, the MSD is “23” dB or “25.7” dB and the 3rd order inter-modulation distortion (i.e., IMD3) is the source of interference. “(*1)”, which is attached to “25.7” dB, means the MSD that applies when four antenna ports are used. When “EUTRA band” is “3”, the MSD is N/A (Not Applicable). In other words, when “EUTRA band” is “3”, there is no interference by the IMD.

It should be noted that “UL Fc (MHz)” indicates a center frequency of the UL band, “UL/DL BW (MHz)” indicates a bandwidth of the UL/DL band, “UL CLRB” indicates the number of resource blocks, “DL Fc” indicates a center frequency of the DL band, and “Duplex mode” indicates a duplex mode.

Further, in the case where the “SUTRA band” is “1” in the CA band combination “CA_1A-8A”, the MSD is “6” dB or “8.7” dB and the 4th order inter-modulation distortion (i.e., IMD4) is the source of interference. It should be noted that “(*1)”, which is attached to “8.7” dB, means the MSD that applies when four antenna ports are used. When “SUTRA band” is “8”, the MSD is N/A (Not Applicable). In other words, when “SUTRA band” is “8”, there is no interference by the IMD.

Here, the user apparatus 200 may transmit, as the terminal capability, the MSD for each DL band for each UL band combination for the LTE-NR dual connectivity to the base station apparatus 100. For example, in FIG. 6, in the case of “CA_1A-3A”, the user apparatus 200 may transmit, as the terminal capability, information indicating the MSD “23” or “25.7” to the base station apparatus 100. The base station apparatus 100 performs appropriate scheduling based on the received MSD.

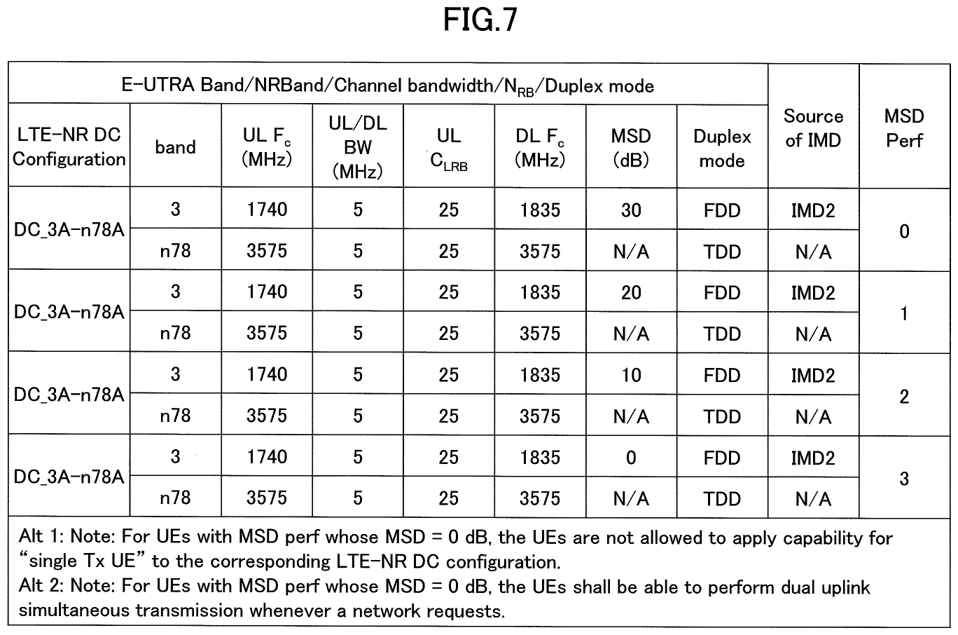

FIG. 7 is a drawing illustrating an example of a capability indication related to MSD according to an embodiment of the present invention. The user apparatus 200 may transmit, to the base station apparatus 100, 100, a predetermined length of bitmap for each band combination with respect to the band combination for the UL and DL LTE-NR dual connectivity. In the case where a predetermined bit in the bitmap is set to “TRUE”, the base station apparatus 100 may perform scheduling based on a predefined MSD related condition corresponding to the bit. The predetermined length of bitmap may indicate a numerical value.

In FIG. 7, each of four “LTE-NR DC Configuration” listings is “DC_3A-n78A”. It should be noted that “DC” indicates dual connectivity. In the band combination listings of “DC_3A-n78A” illustrated in FIG. 7: “Band 3”, which is an LTE 1.7 GHz band, supports a CC with a bandwidth of 5 MHz, with the number of resource blocks, 25, the UL band center frequency, 1740 MHz, the DL band center frequency, 1835 MHz, and the duplex mode, FDD; and “Band n78A”, which is an NR 3.5 GHz band, supports a CC with a bandwidth of 5 MHz, with the number of resource blocks, 25, the UL band center frequency, 3575 MHz, the DL band center frequency, 3575 MHz, and the duplex mode, TDD. Further, in any one of the “DC_3A-n78A” listings, with respect to “band n78”, the MSD is “N/A”, and thus, no interference is generated by IMD.

On the other hand, with respect to “band 3”, different MSDs are defined for four listings of the band combination, “DC_3A-n78A”. As illustrated in FIG. 7, the MSDs, 30 dB, 20 dB, 10 dB, and 0 dB are defined for respective band combination listings. Further, with respect to the information “MSD Perf”, which is transmitted from the user apparatus 200 to the base station apparatus 100, “0” is defined for the band combination with MSD 30 dB, “1” is defined for the band combination with MSD 20 dB, “2” is defined for the band combination with MSD 10 dB, and “3” is defined for the band combination with MSD 0 dB. It should be noted that, in any one of the band combination listings, the interference source is the second inter-modulation distortion (i.e., IMD2).

It should be noted that “Alt 1” in FIG. 7 indicates that the-above described terminal capability “single Tx UE” referring to FIG. 6 is not applied to the user apparatus 200 in which the MSD is 0 dB in “LTE-NR DC Configuration”. Further, “Alt 2” in FIG. 7 indicates that the user apparatus 200, in which the MSD is 0 dB in “LTE-NR DC Configuration”, performs simultaneous UL transmission in the case where it is requested by the network.

In the following, an example of terminal capability transmission using “MSD Perf” illustrated in FIG. 7 will be described. It is assumed that the user apparatus 200 supports UL dual-transmission (simultaneous-transmission) and UL single-transmission in the band combination “DC_3A-n78A”.

For example, in the case where almost no IMD2 is generated because of a good implementation performance of the user apparatus 200, that is, in the case where the MSD can be regarded as 0 dB, the user apparatus 200 transmits, to the base station apparatus 100, “UECapabilityInformation” in which “MSD Perf” is “3”. On the other hand, in the case where a relatively great amount of IMD2 is generated because of a not-so-good implementation performance of the user apparatus 200, for example, in the case where the MSD only satisfies 30 dB, the user apparatus 200 transmits, to the base station apparatus 100, “UECapabilityInformation” in which “MSD Perf” is “0”.

It is possible for the base station apparatus 100 to determine an interference state with respect to DL in band 3 according to the “MSD Perf” transmitted from the user apparatus 200.

In an embodiment described above, it is possible for the base station apparatus 100 to obtain information related to the terminal capability of the user apparatus 200 for the multi-RAT dual connectivity by causing the user apparatus 200 to transmit, to the base station apparatus 100, as the terminal capability (i.e., UECapabilityInformation), the band combination including the LTE band and the NR band for the multi-RAT dual connectivity using different RATs.

Further, in the case where a UL band combination for the LTE-NR dual connectivity is transmitted using “UECapabilityInformation”, it is possible for the base station apparatus 100 to obtain information indicating that the user apparatus 200 supports UL simultaneous-transmission in the UL band combination.

Further, in the case where, using “UECapabilityInformation”, a UL band combination for the LTE-NR dual connectivity is transmitted and the terminal capability “single Tx UE” is transmitted, it is possible for the base station apparatus 100 to obtain information indicating that the user apparatus 200 performs transmission using a single CC in one of the bands of the UL band combination.

Further, in the case where, using “UECapabilityInformation”, a UL band combination for the LTE-NR dual connectivity is transmitted and the terminal capability “not capable of simultaneous transmission in the band combination” is transmitted, it is possible for the base station apparatus 100 to obtain information indicating that the user apparatus 200 is not capable of performing the simultaneous transmission in the UL band combination.

As described above, in the case where the UL simultaneous-transmission is performed, it is possible for the base station apparatus 100 to perform scheduling by taking into account the IMD influence on DL by causing the user apparatus 200 to transmit, to the base station apparatus 100, information indicating whether the user apparatus 200 is capable of UL simultaneous-transmission in the UL band combination.

Further, in the case where, using “UECapabilityInformation”, a UL band combination for the LTE-NR dual connectivity is transmitted and the terminal capability “MSD Perf” is transmitted, it is possible for the base station apparatus 100 to obtain information indicating the MSD in the case of performing UL simultaneous-transmission in the UL band combination. By receiving the “UECapabilityInformation”, it is possible for the base station apparatus 100 to determine what degree of interference will be generated by the IMD for which DL band, and thus, it is possible for the base station apparatus 100 to perform scheduling that is less affected by IMD by selecting the UL dual-transmission or the UL single-transmission.

In other words, it is possible to perform communications in which influence of the in-device interference is reduced in the dual connectivity performed between multiple wireless communication systems using different RATs.

(Apparatus Structure)

Next, examples of functional structures of the base station apparatus 100 and the user apparatus 200 that perform the processes and operations described above will be described. The base station apparatus 100 and the user apparatus 200 each have at least functions for performing an embodiment of the present invention. It should be noted that the base station apparatus 100 and the user apparatus 200 each may have only a part of the functions for performing an embodiment of the present invention.

FIG. 7 is a drawing illustrating an example of a functional structure of a base station apparatus 100. As illustrated in FIG. 7, the base station apparatus 100 includes a transmission unit 110, a reception unit 120, a setting information management unit 130, and a terminal capability management unit 140. The functional structure illustrated in FIG. 7 is merely an example. Functional divisions and names of functional units may be anything as long as operations can be performed according to an embodiment of the present invention.

The transmission unit 110 has a function for generating a signal to be transmitted to the user apparatus 200 and for transmitting the signal wirelessly. The reception unit 120 has a function for receiving various signals transmitted from the user apparatus 200 and for obtaining, for example, upper layer information from the received signals. Further, the transmission unit 110 has a function for transmitting, to the user apparatus 200, PSS or NR-SSS, SSS or NR-SSS, PBCH or NR-PBCH, DL/UL control signals, etc. Further, the transmission unit 110 transmits, to the user apparatus 200, a message for requesting the terminal capability indication and information indicating the UL or DL scheduling. The reception unit 120 receives a message related to the terminal capability indication from the user apparatus 200.

The setting information management unit 130 stores preset setting information and various setting information items to be transmitted to the user apparatus 200. Contents of the setting information are, for example, information related to the band combination, information related to the terminal capability, etc.

The terminal capability management unit 140 performs control of transmission, from the base station apparatus 100 to the user apparatus 200, of a request message for the terminal capability indication such as a “UECapabilityEnquiry”, and performs control of communications corresponding to the terminal capability by receiving the terminal capability indication from the user apparatus 200.

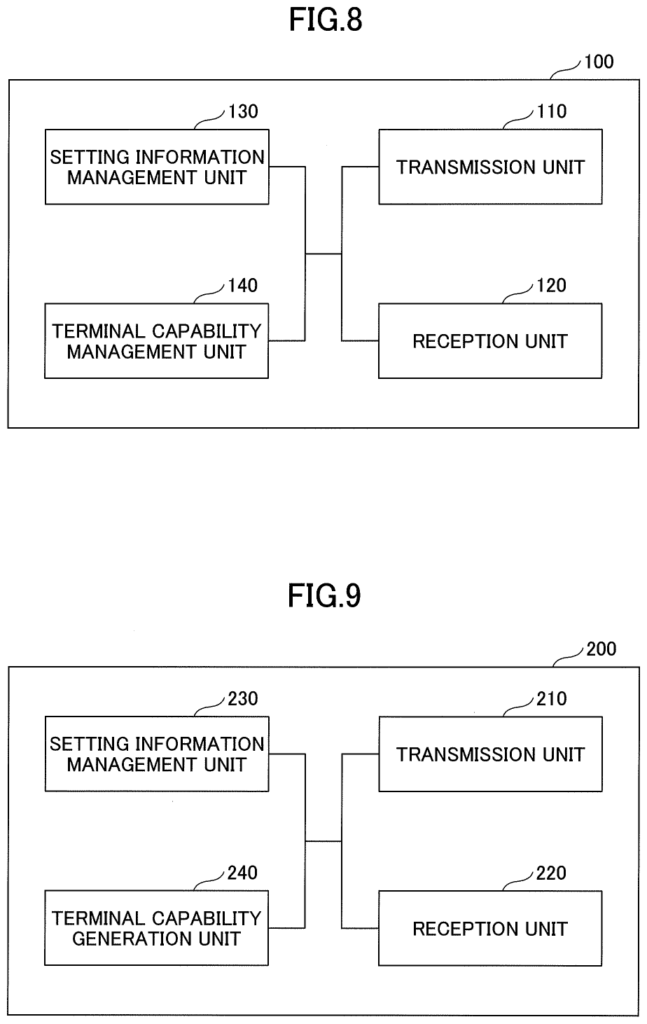

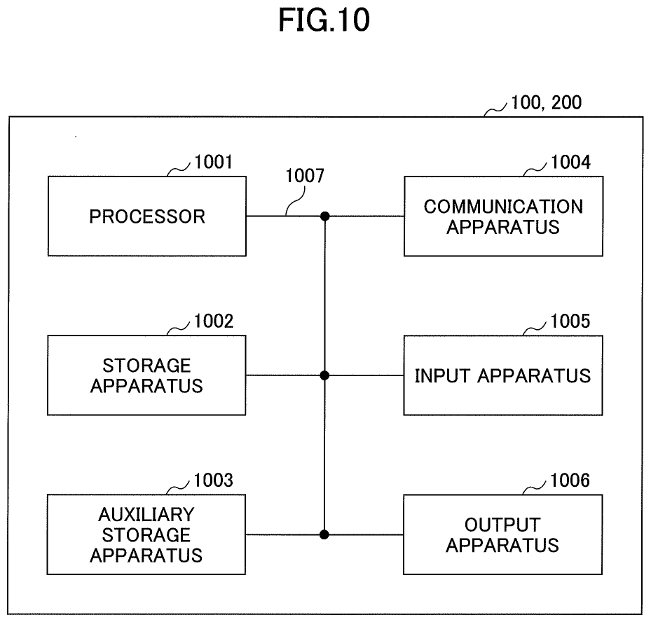

FIG. 8 is a drawing illustrating an example of a functional structure of a user apparatus 200. As illustrated in FIG. 8, the user apparatus 200 includes a transmission unit 210, a reception unit 220, a setting information management unit 230, and a terminal capability generation unit 240. The functional structure illustrated in FIG. 8 is merely an example. Functional divisions and names of functional units may be anything as long as operations can be performed according to an embodiment of the present invention.

The transmission unit 210 generates a transmission signal from transmission data and transmits the transmission signal wirelessly. The reception unit 220 receives various signals wirelessly and obtains upper layer signals from the received physical layer signals. Further, the reception unit 220 has a function for receiving the PSS or NR-PSS, the SSS or NR-SSS, the PBCH or NR-PBCH, the DL/UL control signals, etc., transmitted from the base station apparatus 100. Further, the transmission unit 210 transmits, to the base station apparatus 100, a message related to the terminal capability indication. The reception unit 120 receives, from the base station apparatus 100, a message related to the terminal capability indication request and information indicating the UL or DL scheduling.

The setting information management unit 230 stores various setting information items received by the reception unit 220 from the base station apparatus 100. Further, the setting information management unit 230 also stores preset setting information. Contents of the setting information are, for example, information related to the band combination, information related to the terminal capability indication, etc.

The terminal capability generation unit 240 performs controlling generation and transmission of the terminal capability indication message (e.g., “UECapabilityInformation”) to be transmitted from the user apparatus 200 to the base station apparatus 100. It should be noted that the function of the terminal capability generation unit 240 related to the transmission of the terminal capability indication message may be included in the transmission unit 210, and the function of the terminal capability generation unit 240 related to the reception of the terminal capability indication request message may be included in the reception unit 220.

(Hardware Structure)

In the above functional structure diagrams used for describing an embodiment of the present invention (FIG. 7 and FIG. 8), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless).

Further, for example, a base station apparatus 100 and a user apparatus 200 according to an embodiment of the present invention may function as computers that perform processes according to an embodiment of the present invention. FIG. 9 is a drawing illustrating an example of a hardware structure of a wireless communication apparatus that is a base station apparatus 100 or a user apparatus 200 according to an embodiment of the present invention. Each of the base station apparatus 100 and the user apparatus 200 may be physically a computer apparatus including a processor 1001, a storage apparatus 1002, an auxiliary storage apparatus 1003, a communication apparatus 1004, an input apparatus 1005, an output apparatus 1006, a bus 1007, etc.

It should be noted that, in the descriptions below, the term “apparatus” can be read as a circuit, a device, a unit, etc. The hardware structures of the base station apparatus 100 and the user apparatus 200 may include one or more of each of the apparatuses indicated by 1001 to 1006 illustrated in the figure, or may not include some apparatuses.

Each of the functions of the base station apparatus 100 and the user apparatus 200 is realized by causing predetermined software (program) to be read by hardware such as the processor 1001, the storage apparatus 1002, or the like, by causing the processor 1001 to perform calculations, and by causing the processor 1001 to control communications by the communication apparatus 1004, and to control reading and/or writing data by the storage apparatus 1002 and the auxiliary storage apparatus 1003.

The processor 1001 controls the entire computer by, for example, controlling the operating system. The processor 1001 may include a central processing unit (CPU) including an interface with a peripheral apparatus, a control apparatus, a calculation apparatus, a register, etc.

Further, the processor 1001 reads a program (program code), a software module, or data from the auxiliary storage apparatus 1003 and/or the communication apparatus 1004, writes the program, the software module, or the data to the storage apparatus 1002, and performs various processes according to the program, the software module, or the data. As the program, a program is used that causes the computer to perform at least a part of operations according to an embodiment of the present invention described above. For example, the transmission unit 110, the reception unit 120, the setting information management unit 130, and the terminal capability management unit 140 of the base station apparatus 100 illustrated in FIG. 7 may be realized by control programs that are stored in the storage apparatus 1002 and are executed by the processor 1001. Further, for example, the transmission unit 210, the reception unit 220, the setting information management unit 230, and the terminal capability generation unit 240 of the user apparatus 200 illustrated in FIG. 8 may be realized by control programs that are stored in the storage apparatus 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage apparatus 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage apparatus 1002 may be referred to as a register, a cache, a main memory, etc. The storage apparatus 1002 is enabled to store programs (program codes), software modules, or the like, that are executable for performing processes according to an embodiment of the present invention.

The auxiliary storage apparatus 1003 is a computer-readable recording medium, and may include at least one of, for example, an optical disk such as a CD-ROM (Compact Disc ROM), a hard disk drive, a flexible disk, a magneto optical disk (e.g., compact disk, digital versatile disk, Blu-ray (registered trademark) disk), a smart card, a flash memory (e.g., card, stick, key drive), a floppy (registered trademark) disk, a magnetic strip, etc. The auxiliary storage apparatus 1003 may be referred to as an auxiliary storage apparatus. The above recording medium may be a database including the storage apparatus 1002 and/or the auxiliary storage apparatus 1003, a server, or any other appropriate medium.

The communication apparatus 1004 is hardware (transmission and reception device) for communicating with computers via a wired and/or wireless network, and may be referred to as a network device, a network controller, a network card, a communication module, etc. For example, the transmission unit 110 and the reception unit 120 of the base station apparatus 100 may be realized by the communication apparatus 1004. Further, the transmission unit 210 and the reception unit 220 of the user apparatus 200 may be realized by the communication apparatus 1004.

The input apparatus 1005 is an input device that receives an external input (e.g., keyboard, mouse, microphone, switch, button, sensor). The output apparatus 1006 is an output device that outputs something to the outside (e.g., display, speaker, LED lamp). It should be noted that the input apparatus 1005 and the output apparatus 1006 may be integrated into a single apparatus (e.g., touch panel).

Further, the apparatuses including the processor 1001, the storage apparatus 1002, etc., are connected to each other via the bus 1007 used for communicating information. The bus 1007 may include a single bus, or may include different buses between the apparatuses.

Further, each of the base station apparatus 100 and the user apparatus 200 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

### Embodiment Summary

As described above, according to an embodiment of the present invention, a user apparatus that communicates with a base station apparatus is provided. The user apparatus includes a generation unit configured to generate terminal capability information including information indicating an uplink band combination and information indicating whether capable of simultaneous transmission in the uplink band combination, a transmission unit configured to transmit the generated terminal capability information to the base station apparatus, and a reception unit configured to receive an uplink scheduling assignment from the base station apparatus. The user apparatus performs the simultaneous transmission in the uplink band combination based on the uplink scheduling assignment.

According to an embodiment described above, it is possible for the base station apparatus 100 to obtain information related to the terminal capability of the user apparatus 200 for the multi-RAT dual connectivity by causing the user apparatus 200 to transmit, to the base station apparatus 100, as the terminal capability (i.e., UECapabilityInformation), the band combination including the LTE band and the NR band for the multi-RAT dual connectivity using different RATs. Further, in the case where a UL band combination for the LTE-NR dual connectivity is transmitted using “UECapabilityInformation”, it is possible for the base station apparatus 100 to obtain information indicating whether the user apparatus 200 supports UL simultaneous-transmission in the UL band combination, and to perform scheduling. In other words, it is possible to perform communications in which influence of the in-device interference is reduced in the dual connectivity performed in multiple wireless communication systems using different RATs.

In the case of being capable of simultaneous transmission in a first uplink band combination, the information indicating whether capable of simultaneous transmission in the first uplink band combination may not be included in the terminal capability information, and, in the case of not being capable of simultaneous transmission in a second uplink band combination, the information indicating not being capable of simultaneous transmission in the second uplink band combination may be included in the terminal capability information. According to the above arrangement, in the case where a UL band combination for the LTE-NR dual connectivity is transmitted using “UECapabilityInformation”, it is possible for the base station apparatus 100 to obtain information indicating that the user apparatus 200 supports UL simultaneous-transmission in the UL band combination, and to perform scheduling.

In the case of being capable of uplink transmission in each of a plurality of uplink bands included in the uplink band combination, information indicating being capable of single band transmission may be included in the terminal capability information. According to the above arrangement, in the case where, using “UECapabilityInformation”, a UL band combination for the LTE-NR dual connectivity is transmitted and the terminal capability “single Tx UE” is transmitted, it is possible for the base station apparatus 100 to obtain information indicating that the user apparatus 200 is capable of transmission using a single CC in one of the bands of the UL band combination.

A value indicating the maximum sensitivity degradation in case of performing the simultaneous transmission in the uplink band combination may be included in the terminal capability information. According to the above arrangement, it becomes possible for the base station apparatus 100 to perform scheduling that is less affected by the IMD by obtaining the MSD.

The uplink band combination may be associated with values indicating a plurality of maximum sensitivity degradations, and information indicating one of the values indicating the plurality of maximum sensitivity degradations may be included in the terminal capability information. According to the above-described arrangement, it is possible for the base station apparatus 100 to determine which DL bands are affected by IMD and to what extent when UL simultaneous-transmission is performed by the user apparatus 200, and thus, it is possible for the base station apparatus 100 to perform scheduling that is less affected by IMD by appropriately selecting the UL dual-transmission or the UL single-transmission.

Further, according to an embodiment of the present invention, a base station apparatus that communicates with a user apparatus is provided. The base station apparatus includes a management unit configured to request for the terminal capability information including information indicating whether capable of simultaneous transmission in the uplink band combination, a reception unit configured to receive the requested terminal capability information from the user apparatus, and a reception unit configured to transmit an uplink scheduling assignment, determined based on the terminal capability information, to the user apparatus. The base station apparatus performs the simultaneous transmission in the uplink band combination based on the uplink scheduling assignment.

According to the above-described arrangement, it is possible for the base station apparatus 100 to obtain information related to the terminal capability of the user apparatus 200 for the multi-RAT dual connectivity by causing the user apparatus 200 to transmit, to the base station apparatus 100, as the terminal capability (i.e., UECapabilityInformation), the band combination including the LTE band and the NR band for the multi-RAT dual connectivity using different RATs. Further, in the case where a UL band combination for the LTE-NR dual connectivity is transmitted using “UECapabilityInformation”, it is possible for the base station apparatus 100 to perform scheduling by obtaining information indicating whether the user apparatus 200 supports UL simultaneous-transmission in the UL band combination. In other words, it is possible to perform communications in which influence of the in-device interference is reduced in the dual connectivity performed in multiple wireless communication systems using different RATs.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, a user apparatus UE, or a base station eNB has been described by using functional block diagrams. However, the apparatuses may be realized by hardware, software, or a combination of hardware and software. The software executed by a processor included in a user apparatus UE according to an embodiment of the present invention and the software executed by a processor included in a base station eNB according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information transmission (notification, reporting) may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC signaling, MAC signaling, broadcast information (MIB (Master Information Block), SIB (System Information Block))), other signals, or combinations thereof. Further, an RRC message may be referred to as RRC signaling. Further, an RRC message may be, for example, an RRC connection setup message, an RRC connection reconfiguration message, or the like.

An aspect/embodiment described in the present specification may be applied to a system that uses LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), other appropriate systems, and/or a next generation system enhanced based thereon.

The order of processing steps, sequences or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station apparatus 100 in the present specification, may be performed by an upper node in some cases. In a network including one or more network nodes including a base station apparatus 100, it is apparent that various operations performed for communicating with a user apparatus 200 may be performed by the base station apparatus 100 and/or another network node other than the base station apparatus 100 (for example, but not limited to, MME or S-GW). According to the above, a case is described in which there is a single network node other than the base station apparatus 100. However, a combination of multiple other network nodes may be considered (e.g., MME and S-GW).

An aspect/embodiment described in the present specification may be used independently, may be used in combination, or may be used by switching according to operations.

There is a case in which the user apparatus 200 may be referred to, by a person skilled in the arte, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

There is a case in which the base station apparatus 100 may be referred to, by a person skilled in the art, as a NB (NodeB), an eNB (enhanced NodeB), a gNB, a base station, or some other appropriate terms.

As used herein, the term “determining” may encompasses a wide variety of actions. The “determining” may include, for example, a case in which “judging”, “calculating”, “computing”, “processing”, “deriving”, “investigating”, “looking up” (e.g., looking up a table, database, or other data structures), or “ascertaining” is deemed as “determining”. Also, “determining” may include a case in which “receiving” (e.g., receiving information), “transmitting” (e.g., transmitting information), “inputting”, “outputting”, or “accessing” (e.g., accessing data in a memory) is deemed as “determining”. Further, the “determining” may include a case in which “resolving”, “selecting”, “choosing”, “establishing”, “comparing”, or the like is deemed as “determining”. In other words, the “determining” may include a case in which a certain action or operation is deemed as “determining”.

The description “based on” used in the present specification does not mean “based on only” unless otherwise specifically noted. In other words, the phrase “based on” means both “based on only” and “based on at least”.

When the terms “include”, “including”, and variations thereof are used in the present specification or in the claims, the terms are intended to be non-restrictive (to be considered “open terminology”) the same as the term “comprising”. Further, the term “or” used in the present specification or in the claims is intended to be not an “exclusive or”.

Throughout the present specification, in the case where articles “a”, “an”, and “the” are added to a noun as a result of translation, unless otherwise indicated, the noun may be plural.

It should be noted that, in an embodiment of the present invention, the terminal capability generation unit 240 is an example of a generation unit. The terminal capability management unit 140 is an example of a management unit. The “UECapabilityInformation” is an example of the terminal capability information. A bit indicating the correspondence to “single Tx UE” is an example of information indicating the availability of a single band transmission. A bit indicating “not being capable of simultaneous transmission in the UL band combination” is an example of information indicating not being capable of simultaneous transmission. MSD is an example of a value indicating the maximum sensitivity degradation.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. In other words, the descriptions of the present specification are for illustrative purposes only, and are not intended to be limitations to the present invention.

The present application is based on and claims priority to Japanese patent application No. 2017-195877 filed on Oct. 6, 2017, the entire contents of which are hereby incorporated herein by reference.

### DESCRIPTION OF THE REFERENCE NUMERALS

100 Base station apparatus
200 User apparatus
110 Transmission unit
120 Reception unit
130 Setting information management unit
140 Terminal capability management unit
200 User apparatus
210 Transmission unit
220 Reception unit
230 Setting information management unit
240 Terminal capability generation unit
1001 Processor
1002 Storage apparatus
1003 Auxiliary storage apparatus
1004 Communication apparatus
1005 Input apparatus
1006 Output apparatus

What is claimed is:

1. A user apparatus that communicates with a base station apparatus, the user apparatus comprising:
a generation unit configured to generate terminal capability information including information indicating an uplink band combination and information indicating whether capable of simultaneous transmission in the uplink band combination;
a transmission unit configured to transmit the generated terminal capability information to the base station apparatus; and
a reception unit configured to receive an uplink scheduling assignment from the base station apparatus,
wherein the simultaneous transmission is performed in the uplink band combination based on the uplink scheduling assignment.

2. The user apparatus according to claim 1, wherein
the information indicating whether capable of simultaneous transmission in a first uplink band combination is not included in the terminal capability information in a case of being capable of simultaneous transmission in the first uplink band combination, and
information indicating not being capable of simultaneous transmission in a second uplink band combination is included in the terminal capability information in a case of not being capable of simultaneous transmission in the second uplink band combination.

3. The user apparatus according to claim 1, wherein information indicating being capable of single band transmission is included in the terminal capability information in a case of being capable of uplink transmission in each of a plurality of uplink bands included in the uplink band combination.

4. The user apparatus according to claim 1, wherein a value indicating a maximum sensitivity degradation in a case of performing simultaneous transmission in the uplink band combination is included in the terminal capability information.

5. The user apparatus according to claim 4, wherein the uplink band combination is associated with values indicating a plurality of maximum sensitivity degradations, and information indicating one of the values from among the values indicating a plurality of maximum sensitivity degradations is included in the terminal capability information.

6. A base station apparatus that performs communications with a user apparatus, the base station apparatus comprising:
a management unit configured to request for terminal capability information including information indicating whether capable of simultaneous transmission in an uplink band combination;
a reception unit configured to receive the requested terminal capability information from the user apparatus; and
a reception unit configured to transmit to the user apparatus an uplink scheduling assignment that is determined based on the terminal capability information,
wherein the simultaneous transmission is performed in the uplink band combination based on the uplink scheduling assignment.
